(19) United States
(12) Patent Application Publication
(10) Pub. No.: US 2020/0247009 A1
(43) Pub. Date: Aug. 6, 2020

(54) Methods of Making Thermoplastic Vulcanizates

(71) Applicant: ExxonMobil Chemical Patents Inc., Baytown, TX (US)

(72) Inventors: Oscar O. Chung, Houston, TX (US); Lisa Liu, Houston, TX (US)

(21) Appl. No.: 16/635,090

(22) PCT Filed: Jun. 29, 2018
(86) PCT No.: PCT/US2018/040225

§ 371 Date: Jan. 29, 2020

Related U.S. Application Data
(60) Provisional application No. 62/552,697, filed on Aug. 31, 2017.

(51) Int. Cl. B29B 7/74; B29B 7/90; B29B 7/94; B29B 7/48; C08K 5/01

(52) U.S. Cl. CPC B29B 7/7495; B29B 7/90; B29K 2021/003; B29B 7/48; C08K 5/01; B29B 7/94

(57) ABSTRACT

Methods of making thermoplastic vulcanizate are provided, including the steps of (a) extruding an elastomeric component and a thermoplastic polymer component to form a dynamically vulcanized melt; (b) passing the dynamically vulcanized melt into a vessel, comprising two intermeshing, counter-rotating twin screws, to produce a uniform dynamically vulcanized melt; and (c) filtering the uniform dynamically vulcanized melt and recovering a thermoplastic vulcanizate.

### CROSS-REFERENCE OF RELATED APPLICATIONS

This application claims the benefit of Provisional Application No. 62/552,697, filed Aug. 31, 2017, the disclosure of which is incorporated herein by its reference.

### FIELD OF THE INVENTION

The present invention relates to methods of making thermoplastic vulcanizate, and more particularly relates to use of a vessel to produce the same.

### BACKGROUND OF THE INVENTION

Gear type melt pumps can be effective in developing pressure in extrusion processes without generating excessive heat. In the plastics industry, the melt gear pump can achieve higher production rates of compounding, finishing, and dimensional stability of profile extrusions. However, melt gear pumps are not reliable and can provide an inconsistent product quality when filled polymer systems are processed. For example, the filled polymer system may not form uniform thin melt film required to lubricate the journal bearings or support the load on the melt gear pump shafts from downstream high pressure.

The reliability of current melt gear pumps can be improved by adopting different metallurgy and design. However, manufacturing plants still experience unplanned outages due to sudden failures of the pump. Furthermore, when using a melt gear pump, the quality of a thermoplastic vulcanizate is at risk due to inhomogeneity caused by a side stream of polymer melt that suffers from a different thermal and shear profile as the melt passes through the bearings as well as potential backflow of polymer melt through the gears, which can lead to quality concerns. In addition, compounds can thermoset too soon when cured at higher than the target cure level, thereby creating a lack of lubrication and gel quality.

A need exists, therefore, for an improved method of making quality thermoplastic vulcanizate through reliable and consistent thermal and shear operations and without excess heat generation due to positive displacement pumping mechanisms.

### SUMMARY OF THE INVENTION

Disclosed herein is a method of making thermoplastic vulcanizates including the steps of (a) extruding an elastomeric component and a thermoplastic polymer component to form a dynamically vulcanized melt; (b) passing the dynamically vulcanized melt into a vessel, comprising two intermeshing, counter-rotating twin screws, to produce a uniform dynamically vulcanized melt; and (c) filtering the uniform dynamically vulcanized melt and recovering a thermoplastic vulcanizate.

### BRIEF DESCRIPTION OF THE DRAWINGS

FIG. 1 is a block diagram of the system according to the invention.

FIG. 2 is a top view of a vessel.

FIG. 3 is a cross-sectional lateral view of the intermeshing counter-rotating twin screws of an exemplary vessel.

FIG. 3a is an enlarged detail view corresponding to the circular line VIIIa of FIG. 3.

FIG. 4 is a lateral view of the intermeshing counter-rotating twin screws of an exemplary vessel.

FIG. 5 is a front view of the intermeshing counter-rotating twin screws shown in FIG. 3.

FIG. 6 is a perspective view of the intermeshing counter-rotating twin screws of an exemplary vessel.

FIG. 7 is a lateral view of the intermeshing counter-rotating twin screws shown in FIG. 5.

FIG. 8 is a top view of the intermeshing counter-rotating twin screws shown in FIG. 5.

FIG. 9 is a front view of the intermeshing counter-rotating twin screws shown in FIG. 5.

FIG. 10 is a graph representing the data of Example I for SANTOPRENE™ S121-62M100 of the pumping rate and the revolutions per minute (“RPM”) for the different screen packs.

FIG. 11 is a graph representing the data of Example I for SANTOPRENE™ S123-40 of the pumping rate and the RPM for the different screen packs.

FIG. 12 is a graph representing the data of Example I for SANTOPRENE™ S121-73W175 of the pumping rate and the RPM for the different screen packs.

FIG. 13 is a graph representing the combined data of Example I of grades and screen packs tested plotting pumping efficiency and RPM

### DESCRIPTION OF THE PREFERRED EMBODIMENTS

As used herein, the term “copolymer” shall mean polymers comprising two or more different monomers.

As used herein, the term “elastomer” is used interchangeably with the term “rubber” and is intended to mean and include the same composition.

SANTOPRENE™ 121-62M100 refers to a soft, black, UV resistant thermoplastic vulcanizate (“TPV”) in a family of thermoplastic elastomers (TPEs) manufactured by ExxonMobil and useful in injection molding and sealing applications, including automotive applications like trim and gaskets, outdoor applications like lawn and garden equipment, flexible grips, tools, sporting goods, seals, and thin-walled parts. This TPV has a density of 0.910 g/cm³.

SANTOPRENE™ 121-73W175 refers to a soft, black, UV resistant TPV in the thermoplastic elastomer family manufactured by ExxonMobil with a density of 0.970 g/cm³ and useful for applications requiring flex fatigue resistance and ozone resistance, including automotive and industrial applications like seals and gaskets, expansion joints, water stops, and rail pads and rail boots.

SANTOPRENE™ 123-40 refers to a hard, black, UV resistant TPV in the thermoplastic elastomer family manufactured by ExxonMobil with a density of 0.960 g/cm³ and useful for applications requiring flex fatigue resistance and ozone resistance, including automotive applications like exterior trim and weather seals, and outdoor applications.

Screen pack(s) refers to a series of screen of varying mesh sizes used for extrusion processing of plastics and polymers. They prevent contamination in the melted mass during the extrusion process by removing foreign particles and improve mixing. They may be engineered as mesh discs, leaf filters, spot welded mesh packs, rim or framed packs, cylinders, tube filters, or pleated media.

In an embodiment, multilayer screen packs are made from several screens of different mesh sizes by welded them together. In the different mesh size screens, the finest wire screen is in the center of the pack, and the larger mesh opening screen is successively placed outer sides. The screens are placed in a symmetrical fashion, which prevents the screen pack from accidentally being installed backwards. Screen packs are suitable for extrusion processing of plastics, polymers and fibers as useful in filtering out of any particulate and improve products mixing. The screens are essential in preventing contamination during the extrusion process, and effective to keep away mixing of foreign particles in finally equipped extrusion product. In another embodiment, the screen packs are single layer.

Thermoplastic vulcanizate is prepared by dynamically vulcanizing an elastomer. In an extrusion process, an elastomeric component undergoes mixing and shearing with a thermoplastic component to produce a thermoplastic resin. As described herein, improved methods for making thermoplastic vulcanizate (“TPV”) include the use of a vessel having intermeshing counter-rotating twin screws that extrude the elastomeric and thermoplastic components. The intermeshing counter rotating twin screws of the vessel improve pumping and pressure generation capability of the extrusion process without excessive heat generation due to its more positive displacement pumping mechanism. Furthermore, as described, the vessel does not require journal bearings or lubrication of the bearings. Moreover, external heat can be removed or added to the vessel where typical melt gear pumps do not remove or add heat to the process. Melts are processed through the present vessel under uniform thermal and shearing conditions. Lower melt temperature can be achieved even below the inlet temperature while generating enough pressure and pumping to push through screen packs.

### Elastomeric Component

Any elastomer or mixture thereof that is capable of being vulcanized (that is crosslinked or cured) can be used as the elastomeric component (also referred to herein sometimes as the rubber component). Reference to a rubber or elastomer may include mixtures of more than one. Useful elastomers typically contain a degree of unsaturation in their polymeric main chain. Some non-limiting examples of these rubbers include elastomeric polyolefin copolymer elastomers, butyl rubber, natural rubber, styrene-butadiene copolymer rubber, butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrin terpolymer rubber, and polychloroprene.

Vulcanizable elastomers or elastomeric component means and includes polyolefin copolymer rubbers. Copolymer rubbers are made from one or more of ethylene and higher alpha-olefins, which may include, but are not limited to, propylene, 1-butene, 1-hexene, 4-methyl-1 pentene, 1-octene, 1-decene, or combinations thereof, plus one or more copolymerizable, multiply unsaturated comonomer, such as diolefins, or diene monomers. The alpha-olefins can be propylene, 1-hexene, 1-octene, or combinations thereof. These rubbers may lack substantial crystallinity and can be suitably amorphous copolymers.

The diene monomers may include, but are not limited to, 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; 5-vinyl-2-norbornene, divinyl benzene, and the like, or a combination thereof. The diene monomers can be 5-ethylidene-2-norbornene and/or 5-vinyl-2-norbornene. If the copolymer is prepared from ethylene, alpha-olefin, and diene monomers, the copolymer may be referred to as a terpolymer (EPDM rubber), or a tetrapolymer in the event that multiple alpha-olefins or dienes, or both, are used (EAODM rubber).

Elastomeric components that are polyolefin elastomeric copolymers can contain from about 15 to about 90 mole percent ethylene units deriving from ethylene monomer, from about 40 to about 85 mole percent, or from about 50 to about 80 mole percent ethylene units. The copolymer may contain from about 10 to about 85 mole percent, or from about 15 to about 50 mole percent, or from about 20 to about 40 mole percent, alpha-olefin units deriving from alpha-olefin monomers. The foregoing mole percentages are based upon the total moles of the mer units of the polymer. Where the copolymer contains diene units, the copolymers may contain from 0.1 to about 14 weight percent, from about 0.2 to about 13 weight percent, or from about 1 to about 12 weight percent units deriving from diene monomer. The weight percent diene units deriving from diene may be determined according to ASTM D-6047. In some occurrences, the copolymers contain less than 5.5 weight percent, or less than 5.0 weight percent. In others, the copolymers less than 4.5 weight percent, and in other occurrences, less than 4.0 weight percent units deriving from diene monomer. In yet other cases, the copolymers contain greater than 6.0 weight percent, greater than 6.2 weight percent, greater than 6.5 weight percent, or greater than 7.0 weight percent units, and in others, greater than 8.0 weight percent deriving from diene monomer.

The catalyst employed to polymerize the ethylene, alpha-olefin, and diene monomers into elastomeric copolymers can include both traditional Ziegler-Natta type catalyst systems, especially those including titanium and vanadium compounds, as well as titanium, zirconium and hafnium mono- and biscyclopentadienyl metallocene catalysts. Other catalyst systems such as Brookhart catalyst systems may also be employed.

The polyolefinic elastomeric copolymers can have a weight average molecular weight (M_{w}) that is greater than about 150,000 g/mole, or from about 300,000 to about 850,000 g/mole, or from about 400,000 to about 700,000 g/mole, or from about 500,000 to about 650,000 g/mole. In others, M_{w} is less than 700,000 g/mole, less than 600,000 g/mole, or less than 500,000 g/mole. These copolymers have a number average molecular weight (Mₙ) that is greater than about 50,000 g/mole, or from about 100,000 to about 350,000 g/mole, or from about 120,000 to about 300,000 g/mole, or from about 130,000 to about 250,000 g/mole. In these or other occurrences, the Mₙ is less than 300,000 g/mole, less than 225,000 g/mole, or less than 200,000 g/mole.

M_{w} and Mₙ can be characterized by GPC (gel permeation chromatography) using a High Temperature Size Exclusion Chromatograph (SEC), equipped with a differential refractive index detector (DRI), an online light scattering detector (LS), and a viscometer. Experimental details not shown below, including how the detectors are calibrated (with polystyrene standard), are described in: T. Sun, P. Brant, R. R. Chance, and W. W. Graessley, Macromolecules, Volume 34, Number 19, pp. 6812-6820, 2001.

Solvent for the SEC experiment is prepared by dissolving 6 g of butylated hydroxy toluene as an antioxidant in 4 L of Aldrich reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for about 2 hr. All quantities are measured gravimetrically. The TCB densities used to express the polymer concentration in mass/volume units are 1.463 g/mL at room temperature and 1.324 g/mL at 135° C. The injection concentration ranges from 1.0 to 2.0 mg/mL, with lower concentrations being used for higher molecular weight samples. Prior to running each sample the DRI detector and the injector are purged. Flow rate in the apparatus is then increased to 0.5 mL/min, and the DRI was allowed to stabilize for 8-9 hr before injecting the first sample. The LS laser is turned on 1 to 1.5 hr before running samples. As used herein, the term “room temperature” is used to refer to the temperature range of about 20° C. to about 23.5° C.

The concentration, c, at each point in the chromatogram is calculated from the baseline-subtracted DRI signal, I_{DRI}, using the following equation:

c=K_{DRI}I_{DRI}/(dn/dc),

where K_{DRI} is a constant determined by calibrating the DRI, and dn/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, Light Scattering from Polymer Solutions, Academic Press, 1971):

[K_{O}c/ΔR(θ,c)]=[1/MP(θ)]+2A₂c,

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and K_{O} is the optical constant for the system:

$${K}_{o} = \frac{4 {π}^{2} {{n}^{2} ( d n / d c )}^{2}}{{λ}^{4} {N}_{A}} ,$$

in which N_{A} is the Avogadro's number, and dn/dc is the refractive index increment for the system. The refractive index, n=1.500 for TCB at 135° C. and λ=690 nm. In addition, A₂=0.0015 and dn/dc=0.104 for ethylene polymers, whereas A₂=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

M_{w}≡ΣwᵢMᵢ=(ΣNᵢMᵢ²/ΣNᵢMᵢ),

since the weight fraction wᵢ is defined as the weight of molecules of molecular weight Mᵢ divided by the total weight of all the molecules present:

wᵢ=NᵢMᵢ/ΣNᵢMᵢ

The number-average molecular weight, Mₙ, is defined as the sum of the products of the molecular weight Mᵢ of each fraction multiplied by its mole fraction xᵢ:

Mₙ≡ΣxᵢMᵢ=ΣNᵢMᵢ/ΣNᵢ,

since the mole fraction xᵢ is defined as Nᵢ divided by the total number of molecules:

xᵢ=Nᵢ/ΣNᵢ.

In the SEC, a high temperature Viscotek Corporation viscometer is used, which has four capillaries arranged in a Wheatstone bridge configuration with two pressure transducers. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²,

where c was determined from the DRI output.

The branching index (g′, also referred to as g′(vis)) is calculated using the output of the SEC-DRI-LS-VIS method as follows. The average intrinsic viscosity, [η]_{avg}, of the sample is calculated by:

$${[ η ]}_{a v g} = \frac{Σ {{c}_{i} [ η ]}_{i}}{Σ {c}_{i}} ,$$

where the summations are over the chromatographic slices, i, between the integration limits.

The branching index g′ is defined as:

$${g}^{′} = \frac{{[ η ]}_{a v g}}{k {M}_{v}^{α}} ,$$

where k=0.000579 and α=0.695 for ethylene polymers; k=0.0002288 and α=0.705 for propylene polymers; and k=0.00018 and α=0.7 for butene polymers.

Mᵥ is the viscosity-average molecular weight based on molecular weights determined by the LS analysis:

Mᵥ≡(ΣcᵢMᵢ^{α}/Σcᵢ)^{1/α}.

The elastomeric components can have a Mooney Viscosity (ML₁₊₄@125° C.) from about 30 to about 300, or from about 50 to about 250, or from about 80 to about 200, where the Mooney Viscosity is that of the neat polymer. That is, the Mooney Viscosity is measured on non-oil extended rubber, or practically, from the reactor prior to oil extension.

As used herein, Mooney viscosity can be reported using the format: Rotor ([pre-heat time, min.]+[shearing time, min.] @ measurement temperature,), such that ML₁₊₄@125° C. indicates a Mooney viscosity determined using the ML or large rotor according to ASTM D1646-99, for a pre-heat time of 1 minute and a shear time of 4 minutes, at a temperature of 125° C. However, Mooney viscosity values greater than about 100 cannot generally be measured under these conditions. In this event, a higher temperature can be used (i.e., 150° C.), with eventual longer shearing time (i.e., 1+8@125° C. or 150° C.).

In certain occurrences, the Mooney measurement for purposes herein is carried out using a non-standard small rotor. The non-standard rotor design is employed with a change in the Mooney scale that allows the same instrumentation on the Mooney instrument to be used with polymers having a Mooney viscosity over about 100 ML(1+4@125° C.). For purposes herein, this modified Mooney determination is referred to as MST (or Mooney Small Thin). ASTM D1646-99 prescribes the dimensions of the rotor to be used within the cavity of the Mooney instrument. This method allows for both a large and a small rotor, differing only in diameter. These different rotors are referred to in ASTM D1646-99 as ML (Mooney Large) and MS (Mooney Small).

On the other hand, EPDM can be produced at such high molecular weight that the torque limit of the Mooney instrument can be exceeded using these standard prescribed rotors. In these instances, the test is run using the MST rotor that is both smaller in diameter and thinner. Typically, when the MST rotor is employed, the test is also run at different time constants and temperatures. The pre-heat time is changed from the standard 1 minute to 5 minutes, and the test is run at 200° C. instead of the standard 125° C. The value obtained under these modified conditions is referred to herein as MST (5+4@200° C.). Note: the run time of 4 minutes at the end of which the Mooney reading is taken remains the same as the standard conditions. One MST point is approximately equivalent to 5 ML points when MST is measured at (5+4@200° C.) and ML is measured at (1+4@125° C.). Accordingly, for the purposes of an approximate conversion between the two scales of measurement, the MST (5+4@200° C.) Mooney value is multiplied by 5 to obtain an approximate ML(1+4@125° C.) value equivalent.

Mooney viscosities of the multimodal polymer composition may be determined on blends of polymers herein. The Mooney viscosity of a particular component of the blend is obtained herein using the relationship shown in (1):

log ML=nA log MLA+nB log MLB (1),

wherein all logarithms are to the base 10; ML is the Mooney viscosity of a blend of two polymers A and B each having individual Mooney viscosities MLA and MLB, respectively; nA represents the weight % fraction of polymer A in the blend; and nB represents the wt % fraction of the polymer B in the blend.

Equation (1) can determine the Mooney viscosity of blends comprising a high Mooney viscosity polymer (A) and a low Mooney viscosity polymer (B), which have measurable Mooney viscosities under (1+4@125° C.) conditions. Knowing ML, MLA and nA, the value of MLB can be calculated.

However, for high Mooney viscosity polymers (i.e., Mooney viscosity greater than 100 ML(1+4@125° C.), MLA is measured using the MST rotor as described above. The Mooney viscosity of the low molecular weight polymer in the blend is then determined using Equation 1 above, wherein MLA is determined using the following correlation (2):

MLA(1+4@125° C.)=5.13*MSTA(5+4@200° C.) (2).

The polyolefin elastomeric copolymers of ethylene, propylene, and optionally, diene monomers, EPR or EPDM, may be prepared by traditional solution or slurry polymerization processes. These copolymers are not prepared using the known gas-phase processes to avoid the necessity of pre-selection of filler, usually carbon black, by the rubber manufacturer. The elastomer employed is substantially devoid of copolymer prepared by gas-phase processes. Typically, catalysts used in the copolymerization of the elastomers, or rubber, are the single site Ziegler-Natta catalysts, such as vanadium compounds, or the metallocene catalysts for Group 3-6 metallocene catalysts, particularly the bridged mono- or biscyclopentadienyl metallocenes.

### Mixing of the Elastomeric Component

In an embodiment, the elastomer can be in a shredded, ground, granulate, crumb, or pelletized form. These various forms may be collectively referred to as elastomer particles.

The elastomer can contain limited amounts or is devoid of carbon black. As is known, certain elastomers are in the form of small particulates coated with carbon black as a dusting agent, and it is the intent to limit or exclude this type of rubber. Accordingly, the elastomer, as it is introduced to the extruder, includes less than 10 parts by weight, less than 5 parts by weight, and less than 1 part by weight carbon black per 100 parts by weight elastomer. The elastomeric component can be substantially or completely devoid of carbon black, which refers to an amount less than that amount that would otherwise have an appreciable impact on the elastomer or process described herein.

In an embodiment, before it is added to the mixing device used, the elastomeric component can be oil-extended. An oil extension can derive from conventional methods of extending rubber such as where the oil is introduced to the rubber at the location where the rubber is manufactured. In other cases, the oil extension is obtained from introducing oil to the elastomer prior to introducing the elastomer to the mixing device. Oil may be introduced to the elastomer immediately prior to introducing the elastomer to the mixing device. Reference to an oil extension or oil-extended rubber will refer to all forms of oil extension while excluding the addition of free oil to mixing device used in practicing the present methodology, which will be mixed with the elastomer.

Furthermore, in another embodiment of the invention, the elastomeric component may include limited oil extension. The oil extension can be less than 75 parts by weight, less than 70 parts by weight, less than 60 parts by weight, less than 50 parts by weight, less than 35 parts by weight, and less than 25 parts by weight oil per 100 parts by weight rubber. The oil-extended rubber can include from about 0 to less than 75, from about 0 to about 50, and from about 0 to about 25 parts by weight oil per 100 parts by weight rubber. The rubber is non-oil extended. In other words, the rubber is devoid or substantially devoid of oil extension when it is introduced to the extruder.

### Thermoplastic Polymer Component

The thermoplastic polymer component can include a solid, generally high molecular weight polymeric plastic material. A crystalline or a semi-crystalline polymer can have a crystallinity of at least 25 percent as measured by differential scanning calorimetry. Polymers having a high glass transition temperature are also acceptable as the thermoplastic polymer component. Melt temperature of the thermoplastic polymer component should be lower than the decomposition temperature of the rubber. Thermoplastic polymer components can include a mixture of two or more thermoplastic polymer components.

The thermoplastic polymer components can be crystallized polyolefins that are formed by polymerizing alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another alpha-olefin such as 1-butene, 1-hexene, 1-octene, 2-methyl-1-propene, 3-methyl-1-pentene, 4-methyl-1-pentene, 5-methyl-1-hexene or mixtures thereof are also contemplated. These homopolymers and copolymers may be synthesized by using any polymerization technique known in the art such as, but not limited to, the “Phillips catalyzed reactions,” conventional Ziegler-Natta type polymerizations, and metallocene catalysis including, but not limited to, metallocene-alumoxane and metallocene-ionic activator catalysis. Suitable catalyst systems thus include chiral metallocene catalyst systems, see, e.g., U.S. Pat. No. 5,441,920, and transition metal-centered, heteroaryl ligand catalyst systems, see, e.g., U.S. Pat. No. 6,960,635.

Thermoplastic polymer component can be high-crystalline isotactic or syndiotactic polypropylene. These propylene polymers include both homopolymers of propylene, or copolymers with 0.1-30 weight % of ethylene, or C4 to C8 comonomers, and blends of such polypropylenes. The polypropylene generally has a density of from about 0.85 to about 0.91 g/cc, with the largely isotactic polypropylene having a density of from about 0.90 to about 0.91 g/cc. Also, high and ultra-high molecular weight polypropylene that has a low, or even fractional melt flow rate can be used.

The polyolefinic thermoplastic polymer components may have a M_{w} from about 200,000 to about 700,000, and a Mₙ from about 80,000 to about 200,000. These resins may have a M_{w} from about 300,000 to about 600,000, and a Mₙ from about 90,000 to about 150,000. M_{w} and Mₙ may be measured using the same test method described above with respect to the elastomeric component.

These polyolefinic thermoplastic polymer components can have a melt temperature (Tₘ) that is from about 150 to about 175° C., or from about 155 to about 170° C., and from about 160 to about 170° C. The glass transition temperature (T_{g}) of the thermoplastic polymer components can be from about −5 to about 10° C., or from about −3 to about 5° C., and from about 0 to about 2° C.

Tm, Hf, and Tg are measured using Differential Scanning calorimetry (DSC) using commercially available equipment such as a TA Instruments Model Q100. Typically, 6 to 10 mg of the sample, that has been stored at room temperature (about 23° C.) for at least 48 hours, is sealed in an aluminum pan and loaded into the instrument at room temperature (about 23° C.). The sample is equilibrated at 25° C., then it is cooled at a cooling rate of 10° C./min to −80° C. The sample is held at −80° C. for 5 min and then heated at a heating rate of 10° C./min to 25° C. The glass transition temperature is measured from this heating cycle (“first heat”). For samples displaying multiple peaks, the melting point (or melting temperature) is defined to be the peak melting temperature associated with the largest endothermic calorimetric response in that range of temperatures from the DSC melting trace. The T_{g} was measured by again heating the sample from −80° C. to 80° C. at a rate of 20° C./min (“second heat”). The glass transition temperature reported is the midpoint of step change when heated during the second heating cycle. Areas under the DSC curve are used to determine the heat of transition (heat of fusion, Hf, upon melting or heat of crystallization, Hc, upon crystallization, if the Hf value from the melting is different from the Hc value obtained for the heat of crystallization, then the value from the melting (Tm) shall be used), which can be used to calculate the degree of crystallinity (also called the percent crystallinity). The percent crystallinity (X %) is calculated using the formula: [area under the curve (in J/g)/H° (in J/g)]*100, where H° is the heat of fusion for the homopolymer of the major monomer component. These values for H° are to be obtained from the Polymer Handbook, Fourth Edition, published by John Wiley and Sons, New York 1999, except that a value of 290 J/g is used as the equilibrium heat of fusion (H°) for 100% crystalline polyethylene, a value of 140 J/g is used as the equilibrium heat of fusion (H°) for 100% crystalline polybutene, and a value of 207 J/g (H°) is used as the heat of fusion for a 100% crystalline polypropylene.

Thermoplastic polymer components generally can have a melt flow rate of up to 400 g/10 min, but generally have better properties where the melt flow rate is less than about 30 g/10 min., preferably less than 10 g/10 min, or less than about 2 g/10 min, and less than about 0.8 g/10 min. Melt flow rate is a measure of how easily a polymer flows under standard pressure, and is measured by using ASTM D-1238 at 230° C. and 2.16 kg load.

Thermoplastic polymer components can also be characterized by a heat of fusion (Hf), as described above, at least 100 J/g, at least 180 J/g, at least 190 J/g, and at least 200 J/g.

Other thermoplastic polymer components, in addition to crystalline or semi-crystalline, or crystallizable, polyolefins, include, polyimides, polyesters(nylons), poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, and fluorine-containing thermoplastics. Molecular weights are generally equivalent to those of the polyolefin thermoplastics but melt temperatures can be much higher. Accordingly, the melt temperature of the thermoplastic resin chosen should not exceed the temperature at which the rubber will breakdown, that is when its molecular bonds begin to break or scission such that the molecular weight of the rubber begins to decrease.

### Curatives

Any curative agent that is capable of curing or crosslinking the elastomeric copolymer may be used. Some non-limiting examples of these curatives include phenolic resins, peroxides, maleimides, and silicon-containing curatives.

In addition, phenolic resins capable of crosslinking a rubber polymer can be employed. See e.g., U.S. Pat. Nos. 2,972,600 and 3,287,440. The phenolic resin curatives can be referred to as resole resins and are made by condensation of alkyl substituted phenols or unsubstituted phenols with aldehydes, which can be formaldehydes, in an alkaline medium or by condensation of bi-functional phenoldialcohols. The alkyl substituents of the alkyl substituted phenols typically contain 1 to about 10 carbon atoms. Dimethylol phenols or phenolic resins, substituted in para-positions with alkyl groups containing 1 to about 10 carbon atoms can be used. These phenolic curatives are typically thermosetting resins and may be referred to as phenolic resin curatives or phenolic resins. These phenolic resins are ideally used in conjunction with a catalyst system. For example, non-halogenated phenol curing resins are used in conjunction with halogen donors and, optionally, a hydrogen halide scavenger. Where the phenolic curing resin is halogenated, a halogen donor is not required but the use of a hydrogen halide scavenger, such as ZnO, can be used. For a further discussion of phenolic resin curing of thermoplastic vulcanizates, reference is made to U.S. Pat. No. 4,311,628.

Peroxide curatives are generally selected from organic peroxides. Examples of organic peroxides include, but are not limited to, di-tert-butyl peroxide, dicumyl peroxide, t-butylcumyl peroxide, alpha,alpha-bis(tert-butylperoxy)diisopropyl benzene, 2,5 dimethyl 2,5-di(t-butylperoxy)hexane, 1,1-di(t-butylperoxy)-3,3,5-trimethyl cyclohexane, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals and mixtures thereof may be used. Coagents such as triallylcyanurate are typically employed in combination with these peroxides. Coagent combinations may be employed as well. For example, combinations of high-vinyl polydienes and alpha-beta-ethylenically unsaturated metal carboxylates are useful. Coagents may also be employed as neat liquids or together with a carrier. For example, the multi-functional acrylates or multi-functional methacrylates together with a carrier are useful.

Also, the curative and/or coagent may be pre-mixed with the plastic prior to formulation of the thermoplastic vulcanizate, as described in U.S. Pat. No. 4,087,485. For a further discussion of peroxide curatives and their use for preparing thermoplastic vulcanizates, reference can be made to U.S. Pat. No. 5,656,693. When peroxide curatives are employed, the elastomeric copolymer may include 5-vinyl-2-norbornene and 5-ethylidene-2-norbornene as the diene component.

Useful silicon-containing curatives generally include silicon hydride compounds having at least two SiH groups. These compounds react with carbon-carbon double bonds of unsaturated polymers in the presence of a hydrosilylation catalyst. Silicon hydride compounds include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof.

As noted above, hydrosilylation curing of the elastomeric polymer is conducted in the presence of a catalyst. These catalysts can include, but are not limited to, peroxide catalysts and catalysts including transition metals of Group VIII. These metals include, but are not limited to, palladium, rhodium, and platinum, as well as complexes of these metals. For a further discussion of the use of hydrosilylation to cure thermoplastic vulcanizates, reference can be made to U.S. Pat. Nos. 5,936,028 6,251,998, and 6,150,464. When silicon-containing curatives are employed, the elastomeric copolymer employed can include 5-vinyl-2-norbornene as the diene component.

Another useful cure system is disclosed in U.S. Pat. No. 6,277,916 B1, which is incorporated herein by reference. These cure systems employ polyfunctional compounds such as poly(sulfonyl azides).

### Oils

As described above, oil can be employed in the cure system. The oil also be referred to as a process oil or an extender oil or plasticizer. Useful oils include mineral oils, synthetic processing oils, or combinations thereof may act as plasticizers. The plasticizers include, but are not limited to, aromatic, naphthenic, and extender oils. Exemplary synthetic processing oils include low molecular weight polylinear alpha-olefins, and polybranched alpha-olefins. Commercial examples include the SPECTRASYN® oils of ExxonMobil Chemical Co. Plasticizers from organic esters, alkyl ethers, or combinations thereof may also be employed as set out in U.S. Pat. Nos. 5,290,886 and 5,397,832. Suitable esters include monomeric and oligomeric materials having an average molecular weight below about 2,000 g/mole, or below about 600 g/mole. Specific examples include aliphatic mono- or diesters or alternatively oligomeric aliphatic esters or alkyl ether esters.

### Processing Additives

The present thermoplastic vulcanizates can include one or more polymeric processing additives or property modifiers. As described above, a processing additive that can be employed is a polymeric resin that has a very high melt flow index. These polymeric resins include both linear and branched molecules that have a melt flow rate that is greater than about 500 g/10 min, or greater than about 750 g/10 min, or greater than about 1000 g/10 min, or greater than about 1200 g/10 min, and greater than about 1500 g/10 min. Melt flow rate is a measure of how easily a polymer flows under standard pressure, and is measured by using ASTM D-1238 at 230° C. and 2.16 kg load. The thermoplastic elastomers may include mixtures of various branched or various linear polymeric processing additives, as well as mixtures of both linear and branched polymeric processing additives. Reference to polymeric processing additives will include both linear and branched additives unless otherwise specified. One type of linear polymeric processing additive is polypropylene homopolymers. One type of branched polymeric processing additive includes diene-modified polypropylene polymers. Thermoplastic vulcanizates that include similar processing additives are disclosed in U.S. Pat. No. 6,451,915.

Thermoplastic polymers which can be added for property modification include additional non-crosslinkable elastomers, including non-TPV thermoplastics, non-vulcanizable elastomers and thermoplastic elastomers. Examples include polyolefins such as polyethylene homopolymers and copolymers with one or more C3-C8 alpha-olefins. Specific examples include EPR (ethylene-propylene rubber), ULDPE, VLDPE (very low density polyethylene), LLDPE (linear low density polyethylene), HDPE (high density polyethylene), and particularly those polyethylenes commonly known as “plastomers” which are metallocene catalyzed copolymers of ethylene and C4-C8 having a density of about 0.870 to 0.920. Propylene based elastomeric copolymers of propylene and 8-20 weight % of ethylene, and having a crystalline melt point (45-120° C.) are also useful with a polypropylene based thermoplastic phase, for example the random propylene copolymers sold under the name VISTAMAXX™ propylene-based elastomers, by Exxon Mobil Chemical Co. Other thermoplastic elastomers having some compatibility with the principal thermoplastic or rubber, may be added such as the hydrogenated styrene, butadiene and or isoprene, styrene triblock copolymers (“SBC”), such as SEBS, SEPS, SEEPS, and the like. Non-hydrogenated SBC triblock polymers where there is a rubbery mid-block with thermoplastic end-blocks will serve as well, for instance, styrene-isoprene-styrene, styrene-butadiene-styrene, and styrene-(butadiene-styrene)-styrene.

### Other Additives

In addition to the thermoplastic resin, the vulcanizable elastomer, curatives, plasticizers, and any polymeric additive(s), reinforcing and non-reinforcing fillers, antioxidants, stabilizers, lubricants, antiblocking agents, anti-static agents, waxes, foaming agents, pigments, flame retardants and other processing aids known in the plastics or rubber compounding art may be employed. These additives can comprise up to about 50 weight percent of the total composition. Fillers and extenders that can be utilized include conventional inorganics such as calcium carbonate, clays, silica, talc, titanium dioxide, or organic, such as carbon black, as well as organic and inorganic nanosized, particulate fillers. The fillers, such as the carbon black, can be suitably added in combination with a carrier such as polypropylene. The ability to add filler including those other than carbon black, together with the rubber as well as together with a thermoplastic carrier, such as polypropylene, in a single-pass or one-step process wherein all additions are added to one extruder, and mixed prior to the exit of the melt processed thermoplastic vulcanizates from it.

### Amounts

A sufficient amount of the vulcanized elastomeric copolymer can form rubbery compositions of matter which have ultimate elongations greater than 100 percent, and that quickly retract to 150 percent or less of their original length within about 10 minutes after being stretched to 200 percent of their original length and held at 200 percent of their original length for about 10 minutes.

Accordingly, the thermoplastic vulcanizate described herein may comprise at least about 10 percent by weight elastomeric copolymer, or at least about 35 percent by weight elastomeric copolymer, or at least about 45 percent by weight elastomeric copolymer, or at least about 50 percent by weight elastomeric copolymer. More specifically, the amount of elastomeric copolymer within the thermoplastic vulcanizate is generally from about 25 to about 90 percent by weight, or from about 45 to about 85 percent by weight, or from about 60 to about 80 percent by weight, based on the entire weight of the thermoplastic vulcanizate.

The thermoplastic vulcanizate can generally comprise from about 10 to about 80 percent by weight of the thermoplastic polymer component based on the total weight of the elastomeric component and thermoplastic polymer component combined. The thermoplastic vulcanizate can comprise from about 10 to about 80 percent by weight, or from about 15 to about 60 percent by weight, or from about 20 to about 40 percent by weight, and from about 25 to about 35 percent by weight of the thermoplastic polymer component as based on the total weight of the elastomeric component and thermoplastic polymer components combined.

Where a phenolic curative is employed, a vulcanizing amount curative may comprise from about 1 to about 20 parts by weight, or from about 3 to about 16 parts by weight, or from about 4 to about 12 parts by weight, phenolic curative per 100 parts by weight rubber.

The amount of vulcanizing agent should be sufficient to at least partially vulcanize the elastomeric polymer, and the elastomeric polymer may be completely vulcanized.

Where a peroxide curative is employed, a vulcanizing amount of curative may comprise from about 1×10⁻⁴ moles to about 4×10⁻² moles, or from about 2×10⁻⁴ moles to about 3×10⁻² moles, or from about 7×10⁻⁴ moles to about 2×10⁻² moles per 100 parts by weight elastomer.

Where silicon-containing curative is employed, a vulcanizing amount of curative may comprise from 0.1 to about 10 mole equivalents, or from about 0.5 to about 5 mole equivalents, of

SiH per carbon-carbon double bond.

When employed, the thermoplastic vulcanizate may generally comprise from about 1 to about 25 percent by weight of modifier additives based on the total weight of the elastomeric and thermoplastic polymer components combined. Thermoplastic vulcanizate can comprise from about 1.5 to about 20 percent by weight, or from about 2 to about 15 percent by weight of the polymeric processing additive based on the total weight of the elastomeric component and thermoplastic polymer components combined.

Fillers, such as carbon black or clay, may be added in an amount from about 10 to about 250 parts by weight, per 100 parts by weight of rubber. The amount of carbon black that can be used depends, at least in part, upon the type of carbon black and the amount of extender oil that is used.

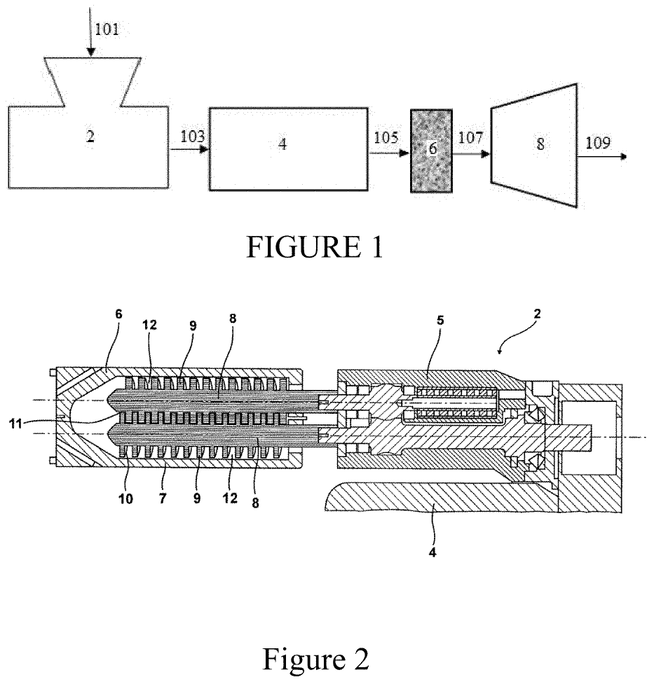

In the present methods, dynamic vulcanization of the thermoplastic polymer component takes place within the vessel 2 of FIG. 2. More than one melt-pump may be used, such as in a tandem arrangement. Preferably, melt-blending takes place with materials being in the melted or molten state.

The thermoplastic vulcanizates of the present disclosure are prepared by dynamic vulcanization techniques. The term “dynamic vulcanization” refers to a vulcanization or curing process for a thermoplastic resin comprising an elastomer, wherein the elastomer is vulcanized under conditions of high shear mixing at a temperature above the melting point of the thermoplastic resin to produce a thermoplastic vulcanizate (“TPV”). In dynamic vulcanization, an elastomer is simultaneously crosslinked and dispersed as fine particles within the polyolefin matrix, although other morphologies may also exist.

As described herein, the melt processing equipment includes a vessel. Other processing equipment can be used, either in tandem or series. The processing equipment (sometimes referred to generally as “processing devices”) used in the present methodologies are capable of mixing the oil, thermoplastic, cure agents, catalyst and can generate high enough temperature for cure.

### Method

Dynamic vulcanization of elastomer typically occurs in the presence of a requisite amount of oil. Generally, thermoplastic vulcanizates are manufactured by adding process oil together with a curative. Introduction of oil before introduction of a curative can improve the cure characteristics of a thermoplastic vulcanizate. Further, the amount of oil added and the location of oil addition can vary to achieve advantageous properties.

In the dynamic vulcanization of thermoplastic melt, especially the melts containing a majority of elastomer, in the early stages of mixing, as the two components are melted together, the lower temperature-melting elastomer component comprises a continuous phase of a dispersion containing the thermoplastic polymer component. As the thermoplastic polymer component melts, and cross-linking of elastomer takes place, the cured elastomer is gradually immersed into the molten thermoplastic polymer and eventually becomes a discontinuous phase, dispersed in a continuous phase of thermoplastic polymer. This is referred to as phase inversion, and if the phase inversion does not take place, the thermoplastic polymer may be trapped in the cross-linked elastomer network of the extruded vulcanizate such that the extrudate created will be unusable for fabricating a thermoplastic product. For temperature, viscosity control and improved mixing, the oil can be added at more than one (1) location along twin screw axis.

Oil injection points (not shown) can be positioned at or before one or more distributive positions, which distributive mixing can be followed by dispersive mixing. This arrangement particularly assists effective blending of the components for ease of processing and uniformity of the final product. Additionally, it is particularly advantageous to add a liquid of oil diluted curative, or molten curative, through an injection port positioned in the same manner. A distributive element (not shown) serves principally to effect homogeneous blending of one component with another and the dispersive mixing element (not shown) serves principally to effect reduction in particle size of the dispersed phase material.

The elastomeric component and at least a portion of a thermoplastic polymer component is first mixed. Mixing may occur in a feed hopper. Following the addition of the elastomer, a curative is added. In as much as the curative can be added at more than one location, and because the curative or cure system (not shown) may include several components, reference to the location or introduction at which the curative is added refers to that point where the final component of the cure system is added to achieve the desired cure level.

Oil can be added together with, or before, the location at which the curative is introduced. The oil added prior to the addition or together with the curative may be referred to as the upstream addition of oil. The oil added after the addition of the curative may be referred to as the downstream addition of the oil. Thus, the present methodologies can include both upstream and downstream addition of oil.

The location at which the upstream addition of oil takes place may include any location together with or after the initial introduction of the elastomeric component up until and including the addition of the curative. In other words, the oil is added after the addition of the elastomeric component, but prior to or together with the curative. Upstream addition of oil includes multiple introductions of oil. For example, the first introduction occurs after the introduction of elastomer component and before the introduction of curative. The second introduction of oil occurs together with the curative. Both introductions can occur after introduction of the elastomeric component but before introduction of the curative. The upstream addition of oil occurs incrementally so that the oil can be gradually introduced to avoid slippage and surging during mixing.

The upstream addition of oil occurs in a manner that the specific energy of the mixing, as measured by the ratio of total power use in kilowatts and extrusion rate in kg/hr, is relatively constant within a standard variation of less than 20%, less than 15%, or less than 10%. The stability of specific energy is an indicator of reduced slip. Similarly, stable measurements can also provide a measure of mixing stability. This can be accomplished by incremental addition of oil or through the selection of appropriate mixing design.

The location at which the upstream addition of oil takes place may be defined with respect to the ratio of the length and diameter of the twin screws. In other words, a particular location can be defined as a particular L (length)/D (diameter) from a particular location (e.g., curative addition or from the upstream edge of the barrel in which the elastomer addition takes place, which normally is at the feed throat). The location is defined with respect to the upstream edge of the barrel in which the curative addition takes place. The upstream addition of oil occurs within 0 L/D, in other embodiments within 20 L/D, and in other embodiments within 30 L/D from the upstream edge of the barrel in which the curative is introduced. The upstream addition of oil may be introduced within 25 L/D, within 20 L/D, and within 10 L/D from the upstream edge of the apparatus in which the elastomer is introduced (but at a location after introduction of the elastomer).

The total amount of oil introduced upstream together with the oil introduced with the elastomer (e.g., oil extension) is at least 50 parts by weight, at least 55 parts by weight, at least 60 parts by weight, at least 65 parts by weight, and at least 70 parts by weight oil per 100 parts by weight elastomer. The total amount of oil introduced upstream together with the oil introduced with the elastomer (e.g., oil extension) is less than 110 parts by weight, less than 105 parts by weight, less than 100 parts by weight, less than 80 parts by weight, and less than 50 parts by weight oil per 100 parts by weight elastomer. The quantity of plasticizer added depends upon the properties desired, with the upper limit depending upon the compatibility of the particular oil and blend ingredients; this limit is exceeded when excessive exuding of plasticizer occurs.

The total amount of oil introduced upstream exclusive of any oil added together with the elastomer (e.g., oil extension) is greater than 8 parts by weight, greater than 12 parts by weight, greater than 20 parts by weight, greater than 30 parts by weight oil per 100 parts by weight elastomer. In these or other examples, the total amount of oil introduced upstream exclusive of any oil introduced with the elastomer may be from about 10 to about 110, from about 30 to about 80, and from about 50 to about 95.

As noted above, the location at which the downstream oil takes place may include any location after the introduction of curative. The location at which the downstream addition of oil takes place may be defined with respect to the ratio of the length and diameter of twin screws. For example, the downstream addition of oil occurs within 25 L/D, within 15 L/D, and within 10 L/D from the location at which the curative is introduced (i.e., downstream of the location at which the curative is introduced).

The amount of oil added downstream, exclusive of any other oil introduced, is at least 5 parts by weight, at least 27 parts by weight, and at least 44 parts weight, and at least 80 parts by weight oil per 100 parts by weight elastomer. The oil added downstream, exclusive of any other oil added, is less than 150 parts by weight, less than 100 parts by weight, less than 50 parts by weight, and less than 25 parts by weight oil per 100 parts by weight elastomer.

The total amount of oil added downstream is such that the total amount of the oil introduced (including oil extension and oil introduced upstream) is from about 25 to about 300 parts by weight, from about 50 to about 200 parts by weight, and from about 75 to about 150 parts by weight per 100 parts by weight elastomer.

Oil can be heated before introduction into the vessel. The amount of thermoplastic added in an initial melt blending step is at least that determined empirically sufficient to allow phase inversion, such that the initial blend becomes one of a continuous thermoplastic phase, and a discontinuous crosslinked elastomer phase upon continued mixing with the addition of curing agent. The curing agent is typically added after effective blending has been achieved between the elastomer and thermoplastic resin component and with continued melt mixing to permit the dynamic crosslinking of the elastomer. Phase inversion then occurs as the crosslinking of the elastomer continues. The additional filler, processing aids, polymeric modifiers, etc., can be added prior to the addition of curative and initiation of crosslinking where such does not interfere with the crosslinking reaction, or after the crosslinking reaction is nearly complete where such may interfere.

Additionally, while the presence of oil during the vulcanization of elastomer can be deleterious when forming conventional thermoset elastomer compositions, the addition of oil can lead to advantageous cure states in thermoplastic vulcanizates. The presence of the oil permits more effective and uniform dispersion of the cross-linking, or curing agents with elastomer to be cured just prior to and during the dynamic curing reaction. Additional thermoplastic, and any other additives, can be added after crosslinking of the elastomer is complete, or at least nearly so, to avoid unnecessary dilution of the active reactants.

Those ordinarily skilled in the art will appreciate the appropriate quantities, types of cure systems, and vulcanization conditions required to carry out the vulcanization of elastomer. Elastomer can be vulcanized by using varying amounts of curative, varying temperatures, and a varying time of cure in order to obtain the optimum crosslinking desired. Because the conventional elastomeric copolymers are not granular and do not include inert material as part of the manufacturing or synthesis of the polymer, additional process steps can be included to granulate or add inert material, if desired, to the conventional elastomeric copolymer.

### Vessel

FIG. 1 is a block diagram of the system according to the invention. Stream 101 includes the elastomeric component, the thermoplastic component, and optionally oil. Stream 101 enters the intermeshing co-rotating twin screw extruder 2 where the materials of Stream 101 are extruded. Stream 103, including a dynamically vulcanized melt, exits the twin screw extruder 2 and enters the vessel 4 where the dynamically vulcanized melt 103 increases in pressure to exit as a uniform dynamically vulcanized melt 105. Optionally, the vessel 4 may have a vent outlet to vent volatiles from the dynamically vulcanized melt 103. Stream 105 then enters screen changer 6 to filter out particles to form the thermoplastic vulcanizate 107. Stream 107 enters the pelletizer and die 8 and exits the system as a pelletized thermoplastic vulcanizate 109. While the system of feeding an elastomeric component, a thermoplastic component, and optionally oil into an extruder, a melt pump, and filter are generally known in the art, the inventors have discovered a novel vessel 4 for use in this process which comprises an intermeshing counter-rotating twin screw extruder that provides for more efficient production of thermoplastic vulcanizates than conventional processes that employ melt gear pumps. The vessel 4 of this invention is described in further detail herein.

As shown in FIG. 2, the vessel 2 comprises two intermeshing counter-rotating twin screws (“twin screws”). The vessel 2 further comprises an electric motor 4, a gear 5, and a compressor 6. The intermeshing counter-rotating twin screws 8 are disposed relatively parallel to the housing 7 of the compressor 6 and rotate in opposite directions to one another. The twin screws 8 are connected to the gear 5, which, in turn, is connected to the electric motor 4. Each of the twin screws 8 has a substantially radially protruding, circumferential flight 9, in which the flight 9 of one of the twin screw 8 engages with the flight 9 of the other in such a manner to enable a force-feed of the synthetic melt to occur.

In the vessel 2 shown in FIG. 2, the intermeshing twin screws 8 rotate in opposite directions to one another or are counter-rotating. To ensure a correct, reciprocally accurate engagement with one other, the twin screws 8 can be permanently coupled via the gear 5 so that a synchronous operation is ensured. Thus, both twin screws 8 are driven synchronously.

The housing 7 is formed to correspond with the twin screws 8 in such a manner that a narrow housing gap 10 remains between the outer edge of the flight 9 and the housing 7, whereby the narrow housing gap 10 can be between approximately 0.05 millimeters (mm) and 2 mm. In an example, the narrow housing gap is 0.5 mm

The radially protruding flight 9 and a flank angle on each side of the flight 9 of approximately zero degrees with plane flanks and, more specifically, a plane flight surface results in a flight 9 having a significantly rectangular cross-section. At the same time, the distance between adjacent flights 9 corresponds to the width of the flight 9. As a result, the flight 9 of the one twin screw 8 precisely fits into the interval of the flight 9 of the other twin screw 8. Thus, the gap 11 remaining between the flights 9 and the twin screws 8 is reduced (e.g., reduced to a minimum) and is approximately between 0.05 mm and 2 mm, and preferably 0.5 mm. The desired gap 11 depends on the type of medium used, in which the gap 11 may be increased as the medium viscosity increases.

Due to the gap 11 being reduced (e.g., reduced to a minimum), a seal may be formed between the adjacent twin screws 8 so that chambers 12 are formed between the housing 7, the flights 9 and the twin screws 8, where each chamber 12 is closed by the seal (e.g. the gap acting as a seal) and the synthetic melt contained therein is continuously conveyed. Due to the tightly cogged twin screws 8, a reflux of a part of the synthetic melt is reduced (e.g., reduce to a minimum) so that the pressure loss is also reduced (e.g., reduced to a minimum), for example. In some examples, this is referred to as being axially sealed.

To achieve a high output, the chambers 12 can be designed to be relatively large. This may be achieved by high flights 9, where the ratio of the outer diameter (“Da”) to the core diameter (“Di”) is approximately equal to 2. To implement a relatively small construction size of the vessel 2, twin screws 8 can have approximate length/outer diameter ratio as low as 3.5.

The chambers 12 formed inside the housing 7 are limited outward by the housing 7 and laterally by the flight 9. In the area where the flights 9 of neighboring twin screws 8 engage with one another, the chambers 12 are separated by the sealing effect. Thus, the chamber 12 extends along one channel, for example.

The design of the width of the housing gap 10 and/or the gap 11 may be dependent on the materials used. For example, when processing highly filled plastics with a calcium carbonate proportion of 80% at a required pressure of 250 bar, a width of 0.5 mm has proven to be advantageous. With a medium having a higher fluidity, the gap is made smaller, and with a medium with a lower fluidity, the gap is made larger. In examples with hard particles where fibers or pigments are mixed into the medium, the gap can also be designed to be larger.

Thus, the housing gap 10 and the gap 11 allow for the formation of the quasi closed chamber 12, whereby a pressure buildup toward the perforated disc 3 is achieved, in part, because of a significant reflux of the medium being prevented.

If the pressure locally exceeds the desired amount, the gap acts as a compensation because some of the synthetic melt can escape into the adjacent chamber 12, which lowers the local pressure and may prevent obstruction and/or damage. Thus, the size of the gap also impacts the pressure compensation.

If a higher pressure is required in the tool 3, the housing gap 10 and the gap 11 should and/or must be reduced. This also applies to examples in which a highly viscous synthetic melt is processed. For a synthetic melt of low viscosity, the gap may also be broadened. As a result, the gap should and/or must be chosen for each particular example according to the criteria described herein. A gap width between 0.05 mm and 2 mm has shown to be advantageous. Some of the examples described herein are axially sealed.

The vessel 2 having a gap width of 0.5 mm described herein may be used particularly advantageously for highly filled synthetics (e.g., for plastics with a high solid content, such as calcium carbonate, wood or carbide). Thus, the highly filled synthetic may have a calcium carbonate proportion of approximately at least 80%.

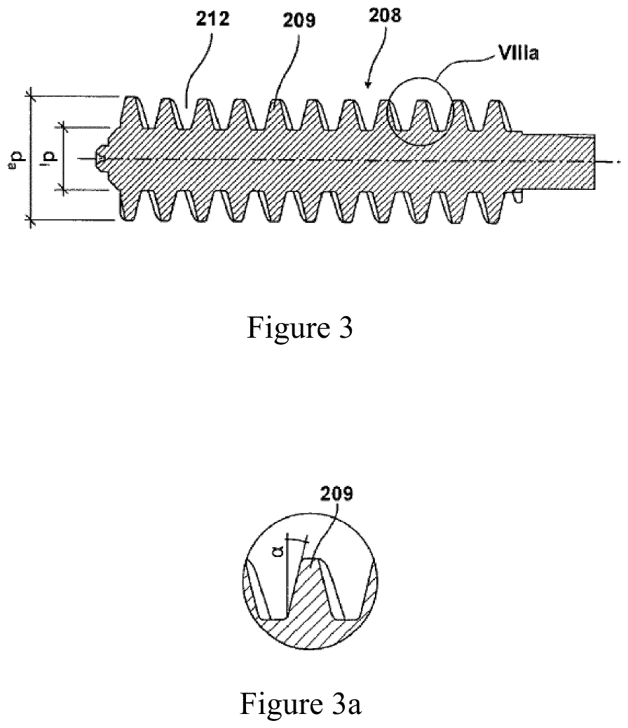

Due to the multiplicity of melts, flank angles, which are also called profile angles, can be adapted into any required form. Thus, counter-rotating twin screws 8 having a rectangular thread profile is shown in FIG. 2. A trapeze-shaped thread profile is shown in FIG. 3. Rectangular thread profiles in FIG. 2 are useful to process polyethylene (PE). The vessel is not limited to that described in FIG. 1.

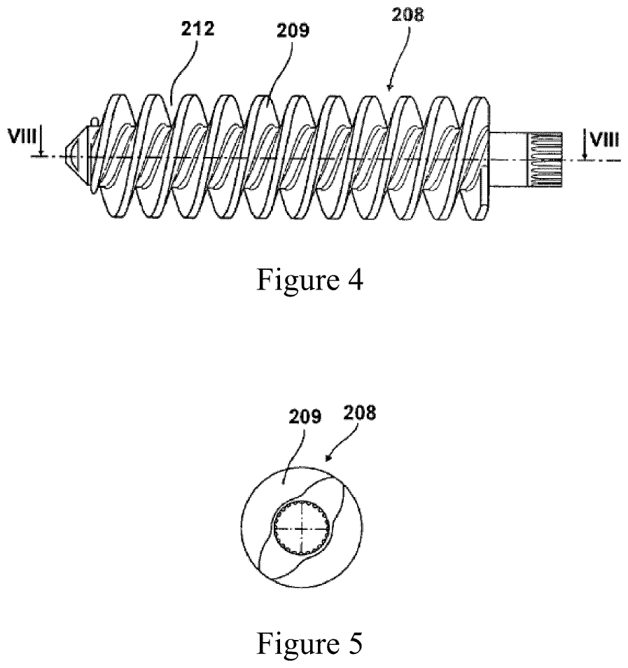

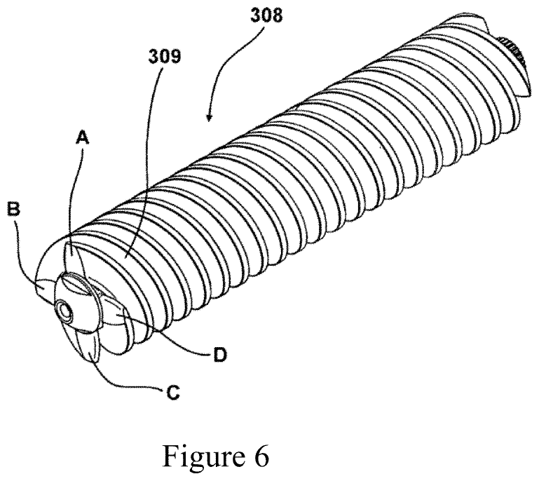

In FIGS. 3-5, counter-rotating twin screws 208 of another exemplary vessel is shown. The counter-rotating twin screws 208 of the illustrated example is double-threaded and having flights 209 designed with substantially trapeze-shaped cross-section with a flank angle of approximately 13°. The twin screws 208 are used in a counter-rotating manner. An axially sealed chamber 212 is formed, which enables pressure buildup and force-feeding. The ratio of Da to Di is approximately equal to 2.

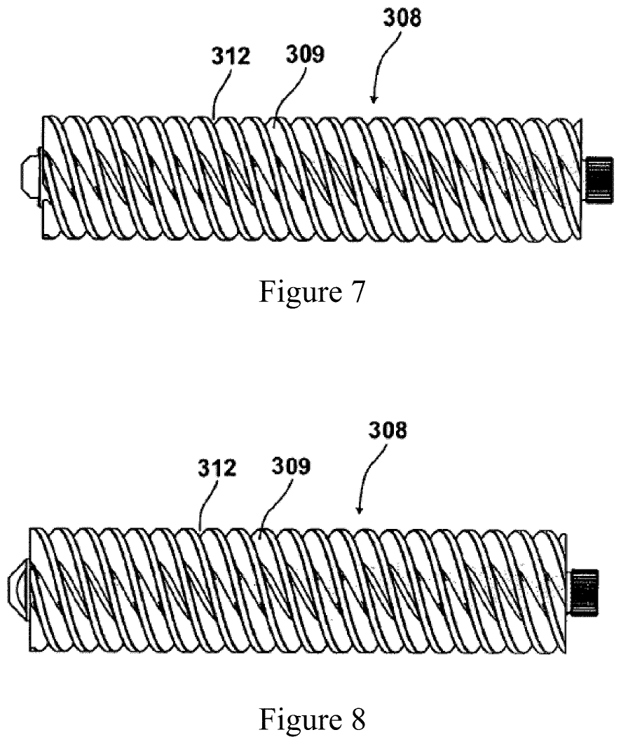

In FIGS. 6-9, the counter-rotating twin screws 308 are quadruple threaded (A, B, C, D) and has rectangular cross-sections 309 with a flank angle of approximately 0°. Twin screws 308 are used in a counter-rotating manner. In this example, axially sealed chambers 312 are formed, which achieve a good pressure buildup and a good force-feed. In this example, the ratio of Da to Di is approximately equal to 2. While the twin screws 208 and 308 described above and shows in FIGS. 3-9 are uniform along the length of the axis, it is appreciated that twin screws that are not uniform along the length of the axis may also be suitable for use in the invention.

The present vessel is designed in such a manner that the twin screws rotate at rotation speeds between approximately 30 rpm and 300 rpm, preferably at rotation speeds between 50 rpm and 150 rpm, depending on the type of the synthetic melt. The chosen rotation speed can be chosen so that the melt is conveyed with significantly reduced or no pulsation.

A gear can be disposed between the compressor and the advantageously electrical drive, by way of which the twin screws are synchronously drivable. A reciprocal, geometrically accurate interlock of the flights is possible because of the synchronization. The second is thereby advantageously not moved along by a mechanical forced coupling as in geared pumps from known examples but rather directly driven, so that high friction with the known disadvantages of high energy consumption and an inevitably associated temperature increase is avoided. This also makes it possible to operate the twin screws so that they rotate in opposite directions. The synchronization from the gear is furthermore advantageous in that drive forces also can be introduced directly into both twin screws, in order to achieve a better force distribution.

By way of example, the flights of both twin screws can engage with each other in such a manner that the flight gap remaining at the narrowest location forms a gap seal. This gap seal prevents the reflux of the medium and increases the force feed and also acts as overpressure compensation. The force feed generates a high pressure buildup and, simultaneously, the pressure compensation prevents damage to the medium, more specifically when the gap seal is adapted to the medium to be processed. The same advantages may also apply to the housing gap.

Another advantage is that the twin screws may be driven with relatively low output, which leads to a smaller drive motor and a lesser energy consumption.

Furthermore, the number of chambers, in which the medium is contained, are formed between the housing and the twin screws or their flights. The chambers can be quasi closed in accordance with the gap seal and/or housing gap so that the desired pressure may be built up but that in examples with a locally excessive pressure, compensation of the pressure occurs.

Moreover, the chamber extends along the pitch of a flight. The beginning and the end of the chamber are thereby located at the intersection of the two twin screws (e.g., in the plane defined by the axes of the two twin screws). This is advantageous in that the medium occupies a defined place and is not mixed with another medium. At the same time, this allows for an efficient pressure build up on the perforated disc.

A housing gap can be formed between the flight and the casing, and a gap is formed between the flight and its adjacent counter-rotating twin screws, which both form a gap seal, so that the medium is substantially held in the respective chamber without a significant reflux of the medium occurring through the gaps (e.g., gap seal) into an adjacent rearward chamber. This is advantageous in that a seal is achieved between the chambers, which allow for a high pressure in each chamber and a pressure of more than 400 bar and up to 600 bar on the perforated disc.

The housing gap and/or the gap can have a width between approximately 0.05 mm and 2 mm. The width of the gap and, thus, the size of the gap seal ultimately dependent on the medium to be processed and its additives. A gap of approximately 0.5 mm has proven advantageous for highly filled plastics with a calcium carbonate proportion of 80% and a pressure of 500 bar on the perforated disc.

Twin screws are configured in such a manner that the ratio of the outer diameter relative to the core diameter is approximately 2. Depending on the type of synthetic melt a ratio between Da and Di having a range of approximately between 1.6 and 2.4 may also be chosen, thereby resulting in a large delivery volume achieved with a relatively thin and, thus, cost-effective vessel. Having a length/diameter ratio of the counter-rotating twin screws of 2 to 5, preferably 3.5, the vessel may achieve a pressure of more than 250 bar and up to 600 bar on the perforated disc. This is advantageous in that the vessel can be manufactured at low cost and utilized in a space-saving manner.

Relatively quick pressure buildup is achieved due to the cooperation of the two accurately intermeshing twin screws with the correspondingly configured flights. High pressures may be achieved, and the retention period in the vessel may be relatively small, and therefore, reducing potential thermal and mechanical damage to the melt.

### EXAMPLE I

Testing was done to understand the pumping performance of the vessel at a pilot plant. The pilot plant was equipped with the vessel (sold as HENSCHEL XTREAMOR™ HMP 2-100) attached to the outlet of a continuous mixer, for example a size #4 continuous mixer available from Farrel (not shown in the figures). One twin screw design of the vessel was employed for the trial. Variables included material viscosity (SANTOPRENE™ grades), production throughput rate, the vessel RPM, and combination of mesh screens. Three different commercial SANTOPRENE™ grades were tested (S121-62M100, S123-40, S121-73W175) to evaluate the impact of material viscosity on the pumping capacity. Two different screen packs were used by choosing different combinations of the melt mesh screens, 20/40/100/20 and 20/20/40/100/200/20, to check the impact of pressure difference across the vessel on pumping efficiency. Three different feed rates were chosen for each material and a screen pack choice and rpm of the vessel was adjusted to make the run stable, and rpm was recorded when the process was stable.

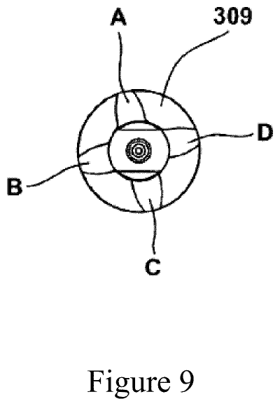

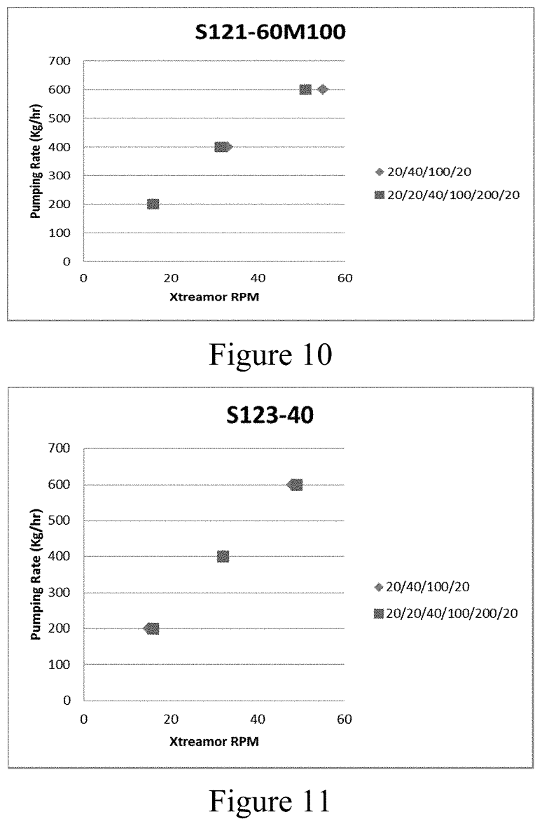

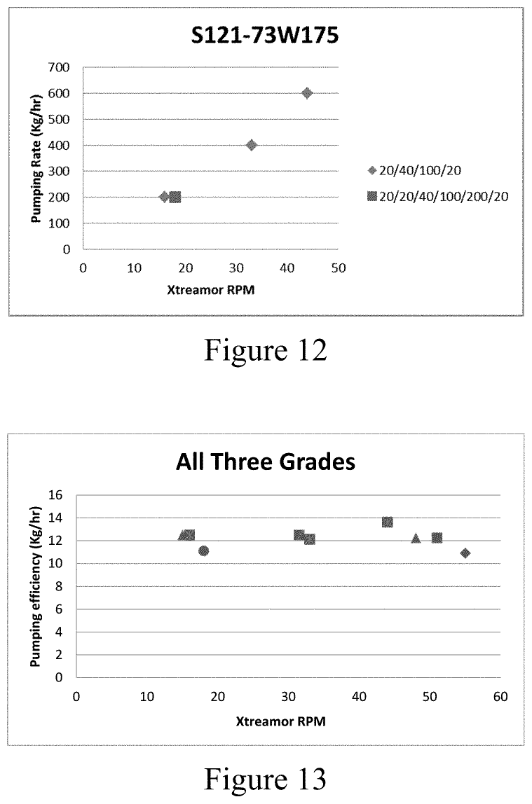

Table 1 shows the testing conditions and results for SANTOPRENE™ S121-62M100. FIG. 9 shows the graphical results of the SANTOPRENE™ S121-62M100 test pumping rate versus the vessel rpm for the different screen packs. Table 2 shows the testing conditions and results for SANTOPRENE™ S123-40. FIG. 10 shows the graphical results of the SANTOPRENE™ S123-40 test pumping rate versus the XTREAMOR™ RPM for the different screen packs. Table 3 shows the testing conditions and results for SANTOPRENE™ S121-73W175. FIG. 11 shows the graphical results of the SANTOPRENE™ S121-73W175 test pumping rate versus the vessel for the different screen packs. FIG. 12 shows the results of the pumping efficiency versus the vessel rpm for all grades and screen pack options. FIG. 13 shows the results of the pumping efficiency versus the vessel rpm for two grades and screen pack options: 1-2 and 1-3 of Table 1 are indicated on FIG. 13 as diamonds; 1-4, 1-5, and 1-6 of Table 1 are indicated on FIG. 13 as squares; 2-1, 2-2, and 2-3 of Table 2 are indicated on FIG. 13 as triangles; 3-1, 3-2, and 3-3 of Table 3 are indicated on FIG. 13 as stars; and 3-4 of Table 13 is indicated on FIG. 13 as a circle.

TABLE 1
SANTOPRENE ™ S121-62M100 Testing Conditions and Results

| | | Pumping | | | | | | |
|---|---|---|---|---|---|---|---|---|
| | | Rate | Suction | Back | | Pumping | Melt | Melt |
| No. | RPM | (Kg/hr) | Pressure | Pressure | Screen | Efficiency | T Out | T In |
| 1-1 | 16 | 200 | 93.6 | 578.76 | 20/40/100/20 | 12.5 | 184 | 197 |
| 1-2 | 33 | 400 | 84.6 | 688.94 | 20/40/100/20 | 12.1 | 185 | 188 |
| 1-3 | 55 | 600 | 89.5 | 874.3 | 20/40/100/20 | 10.9 | 186 | 188 |
| 1-4 | 16 | 200 | 64.9 | 520.38 | 20/20/40/100/ | 12.5 | 183 | 190 |
| | | | | | 200/20 | | | |
| 1-5 | 31.5 | 400 | 60.8 | 616.84 | 20/20/40/100/ | 12.7 | 183 | 185 |
| | | | | | 200/20 | | | |
| 1-6 | 51 | 600 | 57.5 | 731.5 | 20/20/40/100/ | 11.8 | 183 | 184 |
| | | | | | 200/20 | | | |

TABLE 2
SANTOPRENE ™ S123-40 Testing Conditions and Results

| | | Pumping | | | | | | |
|---|---|---|---|---|---|---|---|---|
| | | Rate | Suction | Back | | Pumping | Melt | Melt |
| No. | RPM | (Kg/hr) | Pressure | Pressure | Screen | Efficiency | T Out | T In |
| 2-1 | 15 | 200 | 175.8 | 763.42 | 20/40/100/20 | 13.3 | 188 | 203 |
| 2-2 | 32 | 400 | 196.9 | 1008 | 20/40/100/20 | 12.5 | 191 | 215 |
| 2-3 | 48 | 600 | 182.6 | 1163.26 | 20/40/100/20 | 12.5 | 193 | 216 |
| 2-4 | 16 | 200 | 50.7 | 710.36 | 20/20/40/100/ | 12.5 | 186 | 191 |
| | | | | | 200/20 | | | |
| 2-5 | 32 | 400 | 0 | 1050.56 | 20/20/40/100/ | 12.5 | 185 | 194 |
| | | | | | 200/20 | | | |
| 2-6 | 49 | 600 | 11.9 | 1177.96 | 20/20/40/100/ | 12.2 | 186 | 194 |
| | | | | | 200/20 | | | |

TABLE 3
SANTOPRENE ™ S121-73W175 Testing Conditions and Results

| | | Pumping | | | | | | |
|---|---|---|---|---|---|---|---|---|
| | | Rate | Suction | Back | | Pumping | Melt | Melt |
| No. | RPM | (Kg/hr) | Pressure | Pressure | Screen | Efficiency | T Out | T In |
| 3-1 | 16 | 200 | 166.7 | 883.54 | 20/40/100/20 | 12.5 | 187 | 216 |
| 3-2 | 33 | 400 | 147.6 | 1062.32 | 20/40/100/20 | 12.1 | 188 | 210 |
| 3-3 | 44 | 600 | 154.7 | 1139.18 | 20/40/100/20 | 13.6 | 188 | 205 |
| 3-4 | 18 | 200 | 9.2 | 960.68 | 20/20/40/100/ | 11.1 | 183 | 196 |
| | | | | | 200/20 | | | |

From the trial, we concluded that the vessel was pumping all three SANTOPRENE™ thermoplastic vulcanizates well without any abnormalities observed. Additionally, one screw design worked well for all three TPV (having different viscosities) and the capacity of the vessel. The pumping efficiency was relatively consistent regardless of the screen pack combinations. Lower viscosity grades showed somewhat more leakage flow than hard grades at higher output rate. Although sometimes difficult to measure melt temperature reliably, lower melt temperature was observed, and even lower outlet melt temperature was observed than inlet melt temperature.

Certain features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

The foregoing description of the disclosure illustrates and describes the present methodologies. Additionally, the disclosure shows and describes exemplary methods, but, it is to be understood that various other combinations, modifications, and environments may be employed and the present methods are capable of changes or modifications within the scope of the concept as expressed herein, commensurate with the above teachings and/or the skill or knowledge of the relevant art.

1. A method of making thermoplastic vulcanizate comprising the steps of:
(a) extruding an elastomeric component and a thermoplastic polymer component to form a dynamically vulcanized melt;
(b) passing the dynamically vulcanized melt into a vessel, comprising two intermeshing, counter-rotating twin screws, to produce a uniform dynamically vulcanized melt; and
(c) filtering the uniform dynamically vulcanized melt and recovering a thermoplastic vulcanizate.

2. The method of claim 1, wherein the vessel has an inlet temperature and an outlet temperature, wherein the inlet temperature is the same as the outlet temperature.

3. The method of claim 1, wherein the vessel has an inlet temperature and an outlet temperature, wherein the inlet temperature is higher than the outlet temperature.

4. The method of claim 1, wherein the vessel has a suction pressure between 0 and 1,000 psi.

5. The method of claim 1, wherein the vessel has a discharge pressure between 500 and 5,000 psi.

6. The method of claim 1, further comprising the step of combining oil with the elastomeric component prior to step (a).

7. The method of claim 1, further comprising the step of combining oil with the elastomeric component and the thermoplastic polymer component during step (a).

8. The method of claim 1, further comprising the step of combining the elastomeric component and the thermoplastic polymer component with one or more additives during step (a), where the additives are selected from stabilizers, curatives, processing aids, slip agents, foaming agents, microcapsules, glass beads, fibers, nucleating agents, and acid scavengers.

9. The method of claim 1, further comprising the step of combining oil with the dynamically vulcanized melt during step (b).

10. The method of claim 9, wherein the oil is combined with the dynamically vulcanized melt at a location along an axis of the intermeshing, counter-rotating twin screws of the vessel.

11. The method of claim 1, further comprising the step of combining a curative with the elastomeric component prior to step (a).

12. The method of claim 1, further comprising the step of combining a curative with the elastomeric component and the thermoplastic polymer component during step (a).

13. The method of claim 11, further comprising the step of combining oil with the elastomeric component and the thermoplastic polymer component before combining the curative.

14. The method of claim 9, wherein the oil is heated before being combined with the dynamically vulcanized melt.

15. The method of claim 1, wherein the thermoplastic vulcanizate has a density between 0.80 and 1.0 g/cm³.

16. The method of claim 1, wherein the elastomeric component and the thermoplastic component is extruded in step (a) in an extruder, comprising two intermeshing co-rotating twin screws.

17. A thermoplastic vulcanizate made from the method of claim 1.
